(19) United States
(12) Patent Application Publication
(10) Pub. No.: US 2025/0276243 A1
(43) Pub. Date: Sep. 4, 2025

(54) PROGRAM, IMAGE RENDERING METHOD, AND GAME APPARATUS

(71) Applicant: Cygames, Inc., Tokyo (JP)

(72) Inventors: Yasuhiro Arai, Tokyo (JP); Saori Muto, Tokyo (JP); Wataru Nishimine, Tokyo (JP); Satoshi Hirate, Tokyo (JP); Ryo Hiura, Tokyo (JP)

(73) Assignee: Cygames, Inc., Tokyo (JP)

(21) Appl. No.: 19/211,691

(22) Filed: May 19, 2025

Related U.S. Application Data
(63) Continuation of application No. PCT/JP2023/042788, filed on Nov. 29, 2023.

(30) Foreign Application Priority Data
Dec. 7, 2022 (JP) 2022-195344

(51) Int. Cl. A63F 13/52; G06T 15/20

(52) U.S. Cl. CPC A63F 13/52; G06T 15/20; G06T 2200/24

(57) ABSTRACT

A program for rendering a screen causes a computer to execute: rendering, in a normal operation mode, a specific area including selection operation areas arranged to surround a specific position, normal operation areas provided at an outer side of the selection operation areas, and first special operation areas provided at an inner side of the selection operation areas and indicating contents of special operations; switching an operation mode to a special operation mode through a switching instruction being input; and rendering, in the special operation mode, the specific area in which second special operation areas corresponding to the first special operation areas are arranged at an outer side of the first special operation area.

### TECHNICAL FIELD

The present invention relates to a program, an image rendering method, and a game apparatus.

### BACKGROUND ART

In the related art, a user plays various types of games using a game controller. The controller is provided with various operation buttons for the user to execute complicated operations in the games. The user can perform special operations in the games by pressing a plurality of operation buttons at the same time or pressing different operation buttons in a prescribed order.

For example, in an action game or the like, a user interface is employed that can display an action content of a character on a monitor in association with an operation button of the controller. In such a user interface, a necessary and sufficient display content is required in accordance with an operation content to be performed by the user.

As a technology related to game control, a technology described in Patent Document 1 is known. According to Patent Document 1, “A player character executes a skill action both when it is determined that a simple operation has been input and when it is determined that a normal operation different from the simple operation has been input. When the skill action is executed by inputting the simple operation, a restricted state is maintained for a longer time than when the skill action is executed by inputting the normal operation. In the restricted state, execution of the skill action is restricted, and when a time limit has elapsed, the state is changed to a permitted state, and the skill action becomes executable.”

### CITATION LIST

### Patent Literature

Patent Document 1: JP 6668540 B

### SUMMARY OF INVENTION

### Technical Problem

As described above, an operation method is provided that enables a user to execute a special operation different from a normal operation by performing a certain operation. However, a gauge icon as disclosed in Patent Document 1 merely notifies the user whether a skill action becomes executable. In addition, since a controller is provided with a large number of operation buttons, it is difficult for the user to recognize what operation should be performed to make a desired action executable in a game. For this reason, it is required to present information that makes it easy for the user to perform an operation.

The present invention has been made in view of such circumstances, and an object thereof is to make it easy for a user to recognize an operation content of an operation to be executed.

### Solution to Problem

A program according to the present invention is a program for rendering a screen including, as a part of the screen, a specific area for showing how to perform an operation of a game to be performed via an input part, the program causing a computer to execute: rendering, when an operation mode of the game is a normal operation mode, the specific area including at least three selection operation areas provided in a manner corresponding to selection operation portions provided at the input part, the at least three selection operation areas being arranged to surround a specific position in the specific area, normal operation areas provided at an outer side of the at least three selection operation areas in a manner corresponding to the at least three selection operation areas, the normal operation areas indicating contents of normal operations in the normal operation mode, and first special operation areas provided at an inner side of the at least three selection operation areas in a manner corresponding to the at least three selection operation areas, the first special operation areas indicating contents of special operations in a special operation mode different from the normal operation mode; switching the operation mode from the normal operation mode to the special operation mode through a switching instruction of the operation mode being input from the input part; and rendering, when the operation mode is the special operation mode, the specific area in which second special operation areas corresponding to the first special operation areas are arranged at an outer side of the first special operation areas.

### Advantageous Effects of Invention

According to the present invention, since the operation content of the operation executable by a user is shown in the specific area, the user can easily recognize the operation content to be executed.

Problems, configurations, and effects other than those described above will become apparent from the following description of an embodiment.

### BRIEF DESCRIPTION OF DRAWINGS

FIG. 1 is an overall configuration diagram illustrating an outline of an image rendering system according to an embodiment of the present invention.

FIG. 2 is a block diagram illustrating a hardware configuration example of an information processing apparatus and a content distribution server constituting the image rendering system according to the embodiment of the present invention.

FIG. 3 is a diagram illustrating an external configuration example of an operation controller according to the embodiment of the present invention.

FIG. 4 is a block diagram illustrating an internal configuration example of the information processing apparatus according to the embodiment of the present invention.

FIG. 5 is a diagram illustrating a display form of a specific area when an operation mode is a normal operation mode according to the embodiment of the present invention.

FIG. 6 is an enlarged view illustrating how a parameter indicated by a normal gauge icon changes according to the embodiment of the present invention.

FIG. 7 is a diagram illustrating a display form of a specific area when the operation mode is a special operation mode according to the embodiment of the present invention.

FIG. 8 is an enlarged view illustrating a display form of a special gauge icon in a state where a player character can activate a skill according to the embodiment of the present invention.

FIG. 9 is an enlarged view illustrating a display form of the special gauge icon during a cooldown period according to the embodiment of the present invention.

FIG. 10 is an enlarged view illustrating a display form of the special gauge icon at the end of the cooldown period according to the embodiment of the present invention.

FIG. 11 is an enlarged view illustrating a display form of the special gauge icon at the time of skill activation according to the embodiment of the present invention.

FIG. 12 is an enlarged view illustrating a display example of the specific area in which a remaining number icon is displayed according to the embodiment of the present invention.

FIG. 13 is an enlarged view illustrating how a gauge icon changes when the player character consecutively activates a skill according to the embodiment of the present invention.

FIG. 14 is an enlarged view illustrating how the gauge icon changes until the player character becomes capable of activating the skill according to the embodiment of the present invention.

FIG. 15 is a flowchart illustrating an example of processing of the information processing apparatus according to the embodiment of the present invention.

### DESCRIPTION OF EMBODIMENTS

An embodiment for carrying out the present invention will be described below with reference to the attached drawings. In the present description and the drawings, elements having substantially the same function or configuration are denoted by the same reference numerals, and redundant description thereof will be omitted.

### EMBODIMENT

### Overall Configuration Example of Image Rendering System

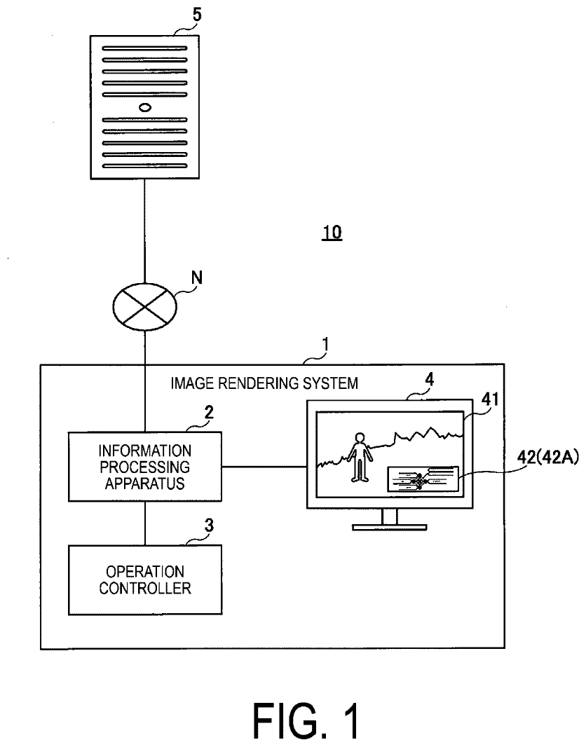

FIG. 1 is an overall configuration diagram illustrating an outline of an image rendering system 1 according to the embodiment.

The image rendering system 1 includes an information processing apparatus 2, an operation controller 3, and a display apparatus 4. The operation controller 3 and the display apparatus 4 are connected to the information processing apparatus 2 in a wireless or wired manner. As the information processing apparatus 2, for example, a dedicated game terminal, a personal computer (PC), or the like is used as an example of a game apparatus according to the present invention. The operation controller 3 is an example of an input part for inputting, to the information processing apparatus 2, input information on an operation performed by a user who uses the information processing apparatus 2.

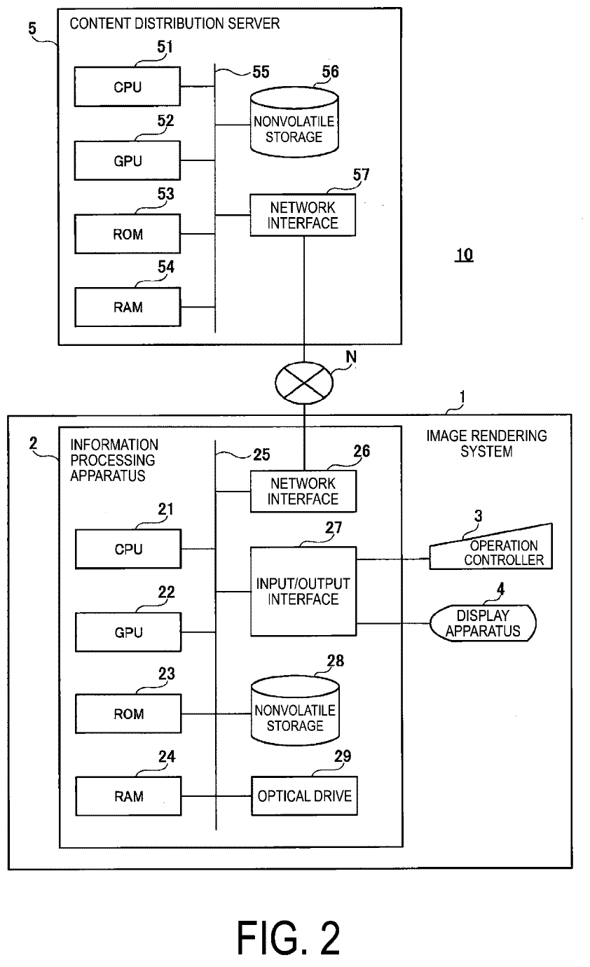

The image rendering system 1 performs, for example, processing in which the information processing apparatus 2 reads and executes a program recorded on an external recording medium such as an optical disk inserted in an optical drive 29 illustrated in FIG. 2 described below, processing in which the information processing apparatus 2 renders a screen in accordance with input information from the operation controller 3, and processing in which the display apparatus 4 displays the screen.

In the present specification, text, still images, moving images, music, sound, and information obtained by combining these are referred to as content. The content is represented by the information processing apparatus 2 executing a program read from a recording medium. In the present specification, a computer game (also abbreviated as a “game”) corresponds to the content. A content-specific operation is controlled by the program of the content itself. Therefore, in the following description, the program and the content may be used with the same meaning.

The program processed by the information processing apparatus 2 according to the present embodiment renders a screen 41 including, as a part thereof, a specific area 42 for showing how to perform a game operation to be performed via the operation controller 3. In this game, a normal operation mode and a special operation mode are provided as operation modes that can be operated by the user using the operation controller 3. The normal operation mode and the special operation mode will be described below in detail.

The information processing apparatus 2 loads a program from an external recording medium, performs predetermined processing, and displays an image as a processing result on the display apparatus 4. Note that the information processing apparatus 2 can record the program on an internal recording medium (hard disk drive (HDD), solid state drive (SSD), or the like) included in the information processing apparatus 2, load the program from the internal recording medium, and perform predetermined processing.

The information processing apparatus 2 executes the program based on an operation signal input from the operation controller 3, and outputs an image signal suitable for screen setting to the display apparatus 4. When the program operated by the operation controller 3 is a game, the information processing apparatus 2 renders a screen in accordance with input information from the operation controller 3 and outputs an image signal for displaying an image of this screen on the display apparatus 4.

The display apparatus 4 displays the image based on the image signal input from the information processing apparatus 2. FIG. 1 illustrates an example of the screen 41 displayed on the display apparatus 4.

For example, in the game loaded by the information processing apparatus 2, the user of the information processing apparatus 2 operates a specific character (referred to as a “player character”) displayed on the display apparatus 4 through the operation controller 3, so that various scenes including the player character are rendered and displayed on the screen of the display apparatus 4.

The player character is an object that can freely move in a two-dimensional virtual space or a three-dimensional virtual space. Examples of assumed operations on the player character from the operation controller 3 include movement of the player character in upward, downward, leftward, rightward, or diagonal directions, movement of a viewpoint for looking down on the scene including the player character, and input of various commands. The player character and the scene displayed on the display apparatus 4 are changed substantially in real time by operating the operation controller 3. Therefore, the scene including the player character corresponding to a position, command, and the like intended by the user is displayed on the display apparatus 4.

An area for assisting with the operation of the player character is displayed on the display apparatus 4. In FIG. 1, the specific area 42 or a specific area 42A that changes according to the operation mode of the game is displayed at a lower right of the screen 41 displayed on the display apparatus 4. That is, when the operation mode is the normal operation mode, the specific area 42 is displayed, and when the operation mode is the special operation mode, the specific area 42A is displayed.

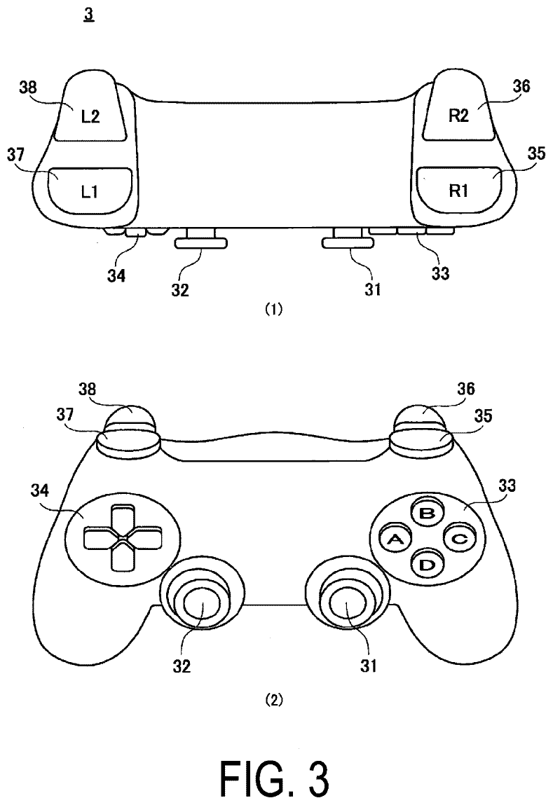

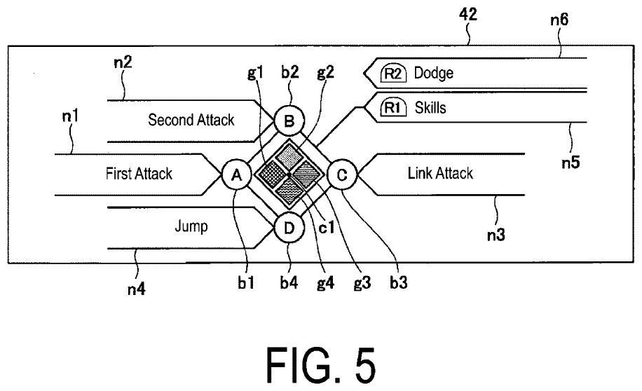

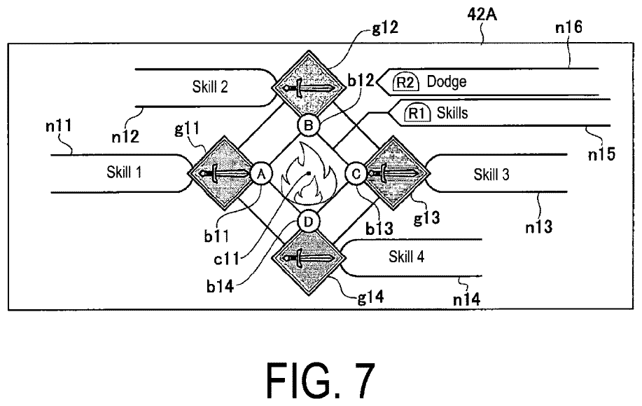

In the specific areas 42 and 42A, various types of information for showing how to perform operations of the player character are displayed. For example, the user can move the player character while switching between a normal operation and a special operation. In the normal operation mode, the user can perform the normal operation using a normal command illustrated in FIG. 5 described below. On the other hand, in the special operation mode, the user can perform the special operation using a special command illustrated in FIG. 7 described below. The user presses, with their index finger, an R1 key 35 (see FIG. 3 described below) serving as an example of a switching button provided at the operation controller 3, so that the user can switch between the normal operation mode and the special operation mode.

### Hardware Configuration Example of Information Processing Apparatus and Content Distribution Server

Next, a hardware configuration example of the information processing apparatus 2 and a content distribution server 5 constituting the image rendering system 1 will be described.

FIG. 2 is a block diagram illustrating the hardware configuration example of the information processing apparatus 2 and the content distribution server 5 constituting the image rendering system 1.

### Configuration Example of Information Processing Apparatus

The information processing apparatus 2 is an example of a computing machine that operates as a computer capable of executing various programs. The information processing apparatus 2 includes a central processing unit (CPU) 21, a graphics processing unit (GPU) 22, a read only memory (ROM) 23, a random access memory (RAM) 24, a network interface 26, an input/output interface 27, a nonvolatile storage 28, and the optical drive 29, which are connected to a bus 25. The image rendering system 1 can be connected to the content distribution server 5 via a network N such as the Internet.

The CPU 21 reads a program code of software for implementing each function according to the present embodiment from the ROM 23, loads the program code into the RAM 24, and executes the program code. Variables, parameters, and the like generated during arithmetic processing of the CPU 21 or the GPU 22 are temporarily written in the RAM 24, and these variables, parameters, and the like are appropriately read by the CPU 21 or the GPU 22. The CPU 21 performs processing of an operating system (OS) of the information processing apparatus 2 and processing such as management of data input/output performed by each unit in the information processing apparatus 2.

The GPU 22 performs processing necessary for rendering a three-dimensional object on a screen, for example. In the following description, rendering processing refers to processing performed by the GPU 22 under instruction of the CPU 21. As illustrated in FIG. 2, the GPU 22 and the CPU 21 may be formed separately, or the GPU 22 may be incorporated in the CPU 21.

For example, a network interface card (NIC) or the like is used as the network interface 26. By using the network interface 26, the information processing apparatus 2 can acquire various types of data via a local area network (LAN), a dedicated line, or the like, connected to a terminal of the NIC and communicate with another information processing apparatus 2 via the network N.

The input/output interface 27 converts an operation signal received from the operation controller 3 into data in a predetermined format and transfers the data to the CPU 21. The input/output interface 27 converts screen data rendered by the GPU 22 into an image signal and outputs the signal to the display apparatus 4. The display apparatus 4 displays, on the screen, an image based on the image signal received from the input/output interface 27. Note that the input/output interface 27 can also output an audio signal to the display apparatus 4. The display apparatus 4 can emit a sound from a speaker (not illustrated) included in the display apparatus 4 based on the audio signal received from the input/output interface 27.

As the nonvolatile storage 28, for example, an HDD, SSD, flexible disk, optical disk, magneto-optical disk, nonvolatile memory, or the like is used. In addition to the OS and various parameters, a program for causing the information processing apparatus 2 to function is recorded in the nonvolatile storage 28. The ROM 23 and the nonvolatile storage 28 records a program, data, and the like necessary for the CPU 21 to operate, and are used as examples of non-transitory computer-readable storage media storing a program to be executed by the information processing apparatus 2.

When the nonvolatile storage 28 is an external recording medium implemented as an optical disk, or the like, the optical drive 29 loads and extracts data from the nonvolatile storage 28. The data extracted by the optical drive 29 is used for predetermined arithmetic processing by the CPU 21 or the GPU 22.

### Configuration Example of Content Distribution Server

The content distribution server 5 manages content and distributes, based on a content acquisition request from an authenticated information processing apparatus 2, the content to the information processing apparatus 2. Therefore, the information processing apparatus 2 may store the content downloaded from the content distribution server 5 on the internal recording medium (such as the nonvolatile storage 28) of the information processing apparatus 2, and load the content from the internal recording medium at the time of content reproduction. Alternatively, the information processing apparatus 2 may receive content streamed from the content distribution server 5 and cause the display apparatus 4 to display the content.

The content distribution server 5 is an example of a computing machine that operates as a computer. The content distribution server 5 includes a CPU 51, a GPU 52, a ROM 53, a RAM 54, a nonvolatile storage 56, and a network interface 57, which are connected to a bus 55.

The CPU 51 reads a program code of software for implementing each function according to the present embodiment from the ROM 53, loads the program code into the RAM 54, and executes the program code. Variables, parameters, and the like generated during arithmetic processing of the CPU 51 or the GPU 52 are temporarily written in the RAM 54, and these variables, parameters, and the like are appropriately read by the CPU 51 or the GPU 52.

When the content distribution server 5 is configured to stream content to the information processing apparatus 2, the content distribution server 5 performs processing of computing a three-dimensional image substantially in real time based on operation data received from the information processing apparatus 2. Thus, for example, the GPU 52 performs processing necessary for rendering a three-dimensional object based on an operation signal received from the information processing apparatus 2 via the network interface 57. An image rendered by the GPU 52 is streamed as image data to the information processing apparatus 2 via the network interface 57, and displayed on the display apparatus 4 connected to the information processing apparatus 2. As illustrated in FIG. 2, the GPU 52 and the CPU 51 may be formed separately, or the GPU 52 may be incorporated in the CPU 51.

As the nonvolatile storage 56, for example, an HDD, SSD, flexible disk, optical disk, magneto-optical disk, nonvolatile memory, or the like is used. In addition to the OS and various parameters, a program for causing the content distribution server 5 to function is recorded in the nonvolatile storage 56. The ROM 53 and the nonvolatile storage 56 record a program, data, and the like necessary for the CPU 51 to operate, and are used as examples of non-transitory computer-readable storage media storing a program to be executed by the content distribution server 5.

For example, an NIC or the like is used as the network interface 57, and various types of data can be transmitted to and received from the information processing apparatus 2 via a LAN, a dedicated line, or the like connected to a terminal of the NIC.

### External Configuration Example of Operation Controller

FIG. 3 is a diagram illustrating an external configuration example of the operation controller 3.

The operation controller 3 is a controller in which a right stick key 31, a left stick key 32, operation buttons 33, a directional pad 34, the R1 key 35, an R2 key 36, an L1 key 37, and an L2 key 38 are attached to one casing. On an upper side of FIG. 3, a plan view (1) of the operation controller 3 is illustrated, and on a lower side of FIG. 3, a front view (2) when the operation controller 3 is viewed from slightly above the front is illustrated.

The right stick key 31 and the left stick key 32 are used for an operation of moving the player character to a position to which it is difficult to move the player character through an operation using the directional pad 34. The right stick key 31 and the left stick key 32 are also used for an operation of changing the viewpoint of the player character.

Four buttons labeled with four types of English letters “A”, “B”, “C”, and “D” are provided as the operation buttons 33. A function for giving an instruction to the player character is assigned to each button. In the present embodiment, at least three of the four buttons among the operation buttons 33 are used as examples of selection operation portions enabling selection of various operations. Note that the operation buttons may be labeled with numbers, figures, or the like.

The directional pad 34 is used for an operation of moving the player character forward, backward, leftward, and rightward. Alternatively, the directional pad 34 may be used for an operation of causing the player character to squat down when the down key is pressed.

At an upper portion of the operation controller 3, the R1 key 35 and the R2 key 36 are provided on a right side, and the L1 key 37 and the L2 key 38 are provided on a left side. For example, each key is used for an operation in which the player character calls a specific function during a battle or an operation of switching display of equipment or stats of the player character. Here, in the present embodiment, the R1 key 35 is used as an example of a switching instruction unit capable of inputting an instruction to switch the operation mode of the game. However, another key (for example, the L1 key 37) of the operation controller 3, a key of a keyboard, or the like may be assigned as the switching instruction unit.

### Internal Configuration Example of Information Processing Apparatus

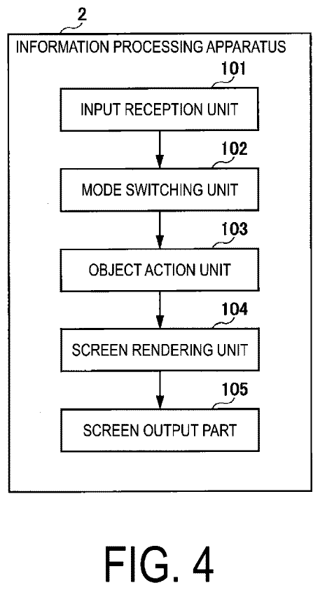

FIG. 4 is a block diagram illustrating an internal configuration example of the information processing apparatus 2.

The information processing apparatus 2 includes an input reception unit 101, a mode switching unit 102, an object action unit 103, a screen rendering unit 104, and a screen output part 105.

The input reception unit 101 receives input information from the operation controller 3. The input reception unit 101 also receives, as the input information, start information of interrupt processing or the like that occurs in a certain scene. In this case, even when there is no input information from the operation controller 3, the scene may be switched or the viewpoint may be moved. Therefore, the input information is also input to the input reception unit 101 by the internal processing of the CPU 21 or the GPU 22.

The mode switching unit 102 is used as an example of an operation mode switching unit that switches the operation mode from the normal operation mode to the special operation mode by inputting an instruction to switch the operation mode as a mode switching signal by pressing the R1 key 35 of the operation controller 3. The mode switching unit 102 is also used as an example of an operation mode switching unit that switches the operation mode from the special operation mode to the normal operation mode.

In the present embodiment, an instruction to switch the operation mode is input as a mode switching signal from the operation controller 3 to the information processing apparatus 2 in both of an operation in which the user presses the R1 key 35 with their finger and an operation in which the user removes their finger from the R1 key 35. Therefore, when the user continues the operation in the special operation mode, it is necessary to keep pressing the R1 key 35.

As described above, the user removes their finger from the R1 key 35 when the operation mode is the special operation mode, and thus a mode switching signal is input again from the operation controller 3, so that the mode switching unit 102 switches the operation mode from the special operation mode to the normal operation mode. In recent games, for example, the difficulty level of the game can be set to “hard”, “normal”, or “easy”. In the present embodiment, when the user selects “normal” or “hard” as the difficulty level of the game, the game can be operated in the special operation mode only while the user presses the R1 key 35.

In the state of the operation mode switched by the mode switching unit 102, the object action unit 103 determines the next action of the player character in accordance with an operation instruction to the player character input from the operation controller 3. In addition, the object action unit 103 performs hit determination at the time of attack in accordance with properties of various objects such as the player character, an enemy character, a building, a road, and a sky arranged in a three-dimensional space, for example, and determines various actions such as movement, attack, and defense of the player character and effect display.

The screen rendering unit 104 renders the screen 41 including the objects determined by the object action unit 103 (see FIG. 1). As described above, the specific area 42 or 42A that changes according to the operation mode is rendered at the lower right of the screen 41. A configuration of the specific area 42 or 42A will be described in detail below.

The screen output part 105 outputs the screen 41 rendered by the screen rendering unit 104 to the display apparatus 4.

The functions of the input reception unit 101 and the screen output part 105 are implemented by the input/output interface 27 illustrated in FIG. 2. Although the functions of the mode switching unit 102, the object action unit 103, and the screen rendering unit 104 are implemented by the GPU 22 illustrated in FIG. 2, these units may be implemented by the CPU 21 when the information processing apparatus 2 does not include the GPU 22.

When the content distribution server 5 is configured to stream content to the information processing apparatus 2, the content distribution server 5 is provided with the input reception unit 101, the mode switching unit 102, the object action unit 103, and the screen rendering unit 104 illustrated in FIG. 4. Then, the content distribution server 5 performs switching of the operation mode, action control of the character object, and screen rendering based on input information including an operation signal received from the information processing apparatus 2 via the network N. Subsequently, display information including the rendered screen is transmitted from the content distribution server 5 to the information processing apparatus 2 via the network N. The information processing apparatus 2 displays the screen on the display apparatus 4 in real time based on the received display information.

### Normal Operation Mode

Next, the operation mode will be described. First, a display form of the specific area 42 when the operation mode is the normal operation mode will be described.

FIG. 5 is a diagram illustrating the display form of the specific area 42 when the operation mode is the normal operation mode.

In the specific area 42, information for showing the user how to perform game operations in the normal operation mode is displayed. By checking the specific area 42, the user can recognize operations that can be instructed to the player character in the normal operation mode. In the specific area 42, button icons b1 to b4 are displayed. “A”, “B”, “C”, and “D” displayed on the button icons b1 to b4 correspond to the positions of the operation buttons 33 of the operation controller 3 (see FIG. 3). Note that the button icons b1 to b4 are used as examples of at least three selection operation areas provided in a manner corresponding to the operation buttons 33. That is, all of the button icons b1 to b4 do not need to be displayed. For example, when only the buttons “A”, “B”, and “C” among the operation buttons 33 are used in the game, only the button icons b1 to b3 may be displayed in the specific area 42. Alternatively, when the operation buttons 33 of the operation controller 3 include five or more buttons, five or more button icons may be displayed in a manner corresponding to the five or more buttons.

The button icons b1 to b4 (examples of the selection operation areas) are arranged so as to surround a specific position c1 indicated by a black dot in the drawing. The specific position c1 is illustrated for description of the positions of various icons displayed in the specific area 42, and is not actually displayed in the specific area 42. The specific position c1 is provided near a center among the button icons b1 to b4, and distances from the specific position c1 to the button icons b1 to b4 are equal to each other. However, by arranging the button icons b1 to b4 in a diamond shape, for example, the distance from the specific position c1 to each of the button icons b1 and b3 may be made different from the distance from the specific position c1 to each of the button icons b2 and b4.

Normal operation areas n1 to n4 are provided at an outer side of the button icons b1 to b4 in a manner corresponding to the button icons b1 to b4. In the normal operation areas n1 to n4, operation contents in the normal operation mode are displayed. For example, “First Attack” is displayed in the normal operation area n1, “Second Attack” is displayed in the normal operation area n2, “Link Attack” is displayed in the normal operation area n3, and “Jump” is displayed in the normal operation area n4. Note that the display contents of the normal operation areas n1 to n4 may change according to the operation. For example, by inputting the first attack many times, the display content of the normal operation area n1 may change from “First Attack” to “First Attack+1” to “First Attack+2”.

For example, when the user presses the operation button 33 being “A” indicated by the button icon b1, the player character of the game can perform an operation of performing the first attack on an enemy character. In this way, an operation of the player character is associated with each button among the operation buttons 33. Since the operation contents are displayed in the normal operation areas n1 to n4, the user can easily recognize what action the player character will perform by pressing each button. Note that the second attack and the link attack refer to operations specific to the game developed by the present applicant.

At an upper right of the specific area 42, guide areas n5 and n6 are also displayed for showing the user what type of operations are performed when the R1 key 35 and the R2 key 36 are pressed in the normal operation mode. For example, “Skills” displayed in the guide area n5 indicates to the user that when the user presses the R1 key 35, a specific skill (referred to as skill) possessed by the player character can be activated. Moreover, “Dodge” displayed in the guide area n6 indicates to the user that when the user presses the R2 key 36, the player character can dodge an attack of an enemy character. In the following description, an operation executable by the user in order for the player character to activate the skill will be referred to as a special operation. In order to perform this special operation, the user needs to press the R1 key 35.

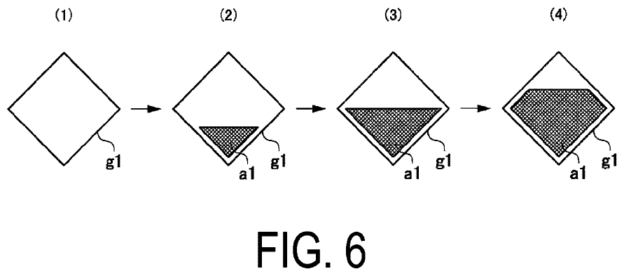

At an inner side of the button icons b1 to b4, normal gauge icons g1 to g4 are displayed as examples of first special operation areas. The normal gauge icons g1 to g4 are provided in a manner corresponding to the button icons b1 to b4 and indicate the content of the special operations in the special operation mode different from the normal operation mode. The screen rendering unit 104 normally renders parameters indicating whether the special operations are executable by the user on the normal gauge icons g1 to g4, and the screen output part 105 outputs a screen on which these parameters are rendered to the display apparatus 4. Here, in each of the normal gauge icons g1 to g4, the parameter (for example, a color area al illustrated in FIG. 6 described below) until the user can execute the special operation is displayed as the content of the special operation in a different color depending on the special operation. Note that the normal gauge icons g1 to g4 illustrated in FIG. 5 indicate that all of the special operations are available. Although the button icons b1 to b4 and the normal gauge icons g1 to g4 are arranged at equal intervals, these icons may be arranged at different intervals.

The parameter increases under a predetermined condition, and when the parameter exceeds a predetermined value, the user can execute the special operation. Then, the special operation is executed, and the player character activates the skill, thereby decreasing the parameter. For example, when the operation mode is the normal operation mode, the parameter is represented by a change in the shape of the color area in each of the normal gauge icons g1 to g4 representing a state until the user becomes capable of executing the special operation. When each of the normal gauge icons g1 to g4 is filled with the color area, the user can execute the special operation. Here, focusing on the normal gauge icon g1, an example of a change in the parameter will be described with reference to FIG. 6.

FIG. 6 is an enlarged view illustrating how the parameter indicated in the normal gauge icon g1 changes. This parameter is represented by the change in the shape of the color area al in the normal gauge icon g1 representing a state until the user becomes capable of executing the special operation.

The change in the parameter indicated by the normal gauge icon g1 is indicated by a change in the dimensions of the color area al displayed inside the normal gauge icon g1. For example, when the player character is attacked by an enemy character or when time elapses in the game, the dimensions of the color area al increase and the shape thereof changes. Then, for example, when the shape of the color area al changes to the same quadrangle as the normal gauge icon g1, and the normal gauge icon g1 is filled with the color area al, the character becomes capable of activating the skill, and thus the user becomes capable of executing the special operation.

The display form of the normal gauge icon g1 sequentially changes from (1) in FIG. 6.

In the display form illustrated in (1) of FIG. 6, the normal gauge icon g1 is in a state in which the color area al is not displayed.

In the display form illustrated in (2) of FIG. 6, the normal gauge icon g1 is in a state in which the color area al is displayed. Here, the color area al is represented in a state of being accumulated at a lower portion of the normal gauge icon g1.

In the display form illustrated in (3) of FIG. 6, the normal gauge icon g1 is displayed in a state in which the dimensions of the color area al are increased. The color area al is represented in a state of being accumulated to about half of the normal gauge icon g1.

In the display form illustrated in (4) of FIG. 6, the normal gauge icon g1 is displayed in a state in which the dimensions of the color area al are increased. This color area al is represented in a state of being accumulated to more than half of the normal gauge icon g1.

### Special Operation Mode

Next, the special operation mode will be described. First, a display form of the specific area 42A when the operation mode is the special operation mode will be described.

FIG. 7 is a diagram illustrating the display form of the specific area 42A when the operation mode is the special operation mode.

In the specific area 42A, information for showing the user how to perform game operations in the special operation mode is displayed. By checking the specific area 42A, the user can recognize skills that the player character can activate in the special operation mode. In the specific area 42A, button icons b11 to b14 are displayed. “A”, “B”, “C”, and “D” displayed on the button icons b11 to b14 correspond to the positions of the operation buttons 33 of the operation controller 3 (see FIG. 3). Note that the button icons b11 to b14 are used as examples of the at least three selection operation areas provided in a manner corresponding to the operation buttons 33.

Here, the button icons b11 to b14 are arranged so as to surround a specific position c11 indicated by a black dot in the drawing. Note that the specific position c11 is illustrated for description of the positions of various icons displayed in the specific area 42A, and is not actually displayed in the specific area 42A. The specific position c11 and the button icons b11 to b14 illustrated in FIG. 7 are displayed at the same positions as the specific position c1 and the button icons b1 to b4 illustrated in FIG. 5 in the normal operation mode. The specific position c11 is provided near the center of the button icons b11 to b14, and distances from the specific position c11 to the button icons b11 to b14 are equal to each other. However, by arranging the button icons b11 to b14 in a diamond shape, for example, the distance from the specific position c11 to each of the button icons b11 and b13 may be made different from the distance from the specific position c11 to each of the button icons b12 and b14.

In addition, when the operation mode is the special operation mode, special gauge icons g11 to g14 are displayed at an outer side of the button icons b11 to b14. The special gauge icons g11 to g14 are provided in a manner corresponding to the button icons b11 to b14 and indicate the content of the special operations in the special operation mode. The special gauge icons g11 to g14 are provided in a manner corresponding to the normal gauge icons g1 to g4 illustrated in FIG. 5 so as to be switched from the normal gauge icons g1 to g4. The special gauge icons g11 to g14 are arranged at an outer side of the normal gauge icons g1 to g4. Although the button icons b11 to b14 and the special gauge icons g11 to g14 are arranged at equal intervals, these icons may be arranged at different intervals.

In each of the special gauge icons g11 to g14, a parameter until the special operation become executable is displayed as the content of the special operation in a different color depending on the special operation. Pictures set for respective skills are displayed inside the special gauge icons g11 to g14. Generally speaking, the pictures displayed inside the special gauge icons g11 to g14 are different for respective skills, but the same picture may be displayed for some skills.

When the operation mode is the special operation mode, the parameter is represented by a change in the shape of a color area in each of the special gauge icons g11 to g14 representing a state until the special operation becomes executable. Each of the special gauge icons g11 to g14 is filled with the color area, and thus the player character enters a state of being capable of activating the skill. The user presses the R1 key 35 to switch the operation mode to the special operation mode, so that the special operation becomes executable. The color areas of all the special gauge icons g11 to g14 when the player character is in a state of being capable of activating the skills may have the same color or different colors. As described above, the colors may match the attributes of the player character (for example, red in the case of a fire attribute and blue in the case of a water attribute).

Note that the special gauge icons g11 to g14 illustrated in FIG. 7 indicate that all of the special operations are available. The screen rendering unit 104 renders the special gauge icons g11 to g14 when the operation mode is the special operation mode in a larger area than the normal gauge icons g1 to g4 when the operation mode is the normal operation mode. As a result, the special gauge icons g11 to g14 are displayed with a larger size than the normal gauge icons g1 to g4 illustrated in FIG. 5.

At an outer side of the special gauge icons g11 to g14, special operation areas n11 to n14 are arranged as examples of second special operation areas in a manner corresponding to the button icons b11 to b14. In FIG. 7, the special operation areas n11 to n14 are displayed so as not to overlap with the button icons b11 to b14, but the special operation areas n11 to n14 may be displayed so as to overlap with the button icons b11 to b14. When the operation mode is the special operation mode, the screen rendering unit 104 renders text or images representing the contents of the special operations at positions matching the positions of the special gauge icons g11 to g14. Then, the screen output part 105 outputs, to the display apparatus 4, the specific area 42A in which the text or images representing the contents of the special operations are rendered.

As the operation contents displayed in the special operation areas n11 to n14, for example, “Skill 1” is displayed in the special operation area n11, and “Skill 2” is displayed in the special operation area n12. For example, when pressing the operation button 33 being “A” indicated by the button icon b11, the user can perform a special operation of causing the player character to activate Skill 1. In this way, an operation of the player character is associated with each button among the operation buttons 33. Since the operation contents are displayed in the special operation areas n11 to n14, the user can easily recognize what operation the player character will perform by pressing each button.

At an upper right of the specific area 42A, guide areas n15 and n16 are also displayed for showing the user what type of operations are performed when the R1 key 35 and the R2 key 36 are pressed in the special operation mode. The display contents and functions of the guide areas n15 and n16 are the same as those of the guide areas n5 and n6 illustrated in FIG. 5.

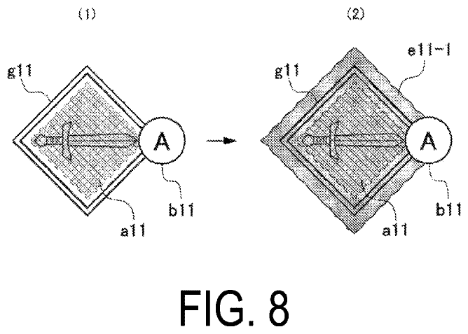

As illustrated in FIGS. 5 and 7, the normal gauge icons g1 to g4 displayed at the inner side of the button icons b1 to b4 in the normal operation mode are displayed at the outer side of the button icons b11 to b14 as the special gauge icons g11 to g14 in the special operation mode. For this reason, in the special operation mode, the user easily visually recognizes the states of the special gauge icons g11 to g14, and thus the user easily determines whether the special operations are executable. In addition, in each of the special gauge icons g11 to g14, a parameter (for example, a color area all illustrated in FIG. 8 described below) until the user can execute the special operation is displayed as the content of the special operation in a different color depending on the special operation. At this time, the screen rendering unit 104 renders the parameters indicating whether the special operations are executable on the special gauge icons g11 to g14, and the screen output part 105 outputs, to the display apparatus 4, a screen on which the parameters are rendered.

An instruction to switch the operation mode is input as a mode switching signal from the operation controller 3, and thus the screen rendering unit 104 renders at least one set of the normal gauge icons g1 to g4 or the special gauge icons g11 to g14 while continuously moving the one set from the inner side to the outer side of the button icons b1 to b4. Here, the screen rendering unit 104 performs rendering processing of enlarging and moving the normal gauge icons g1 to g4 serving as examples of the first special operation areas outward with respect to the specific position c1 while the normal gauge icons g1 to g4 fade out. At the same time as this rendering processing, the screen rendering unit 104 performs rendering processing of moving the special gauge icons g11 to g14 serving as examples of the second special operation areas outward with respect to the specific position c1 while the special gauge icons g11 to g14 fade in. However, the screen rendering unit 104 may display the specific area 42A in the display form illustrated in FIG. 7 after performing only one of the rendering processing operations described above. Since the image is changed from the specific area 42 to the specific area 42A and displayed in this way, the user can easily recognize that the switching instruction has been correctly input from the operation controller 3 and the operation mode has been switched to the special operation mode.

### Display Form of Special Gauge Icon

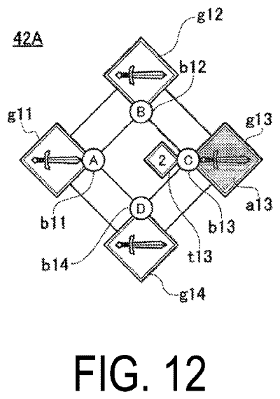

Next, examples of display forms of the special gauge icons g11 to g14 will be described with reference to FIGS. 8 to 14. Note that, in FIGS. 8 to 11, the display forms of the special gauge icon g11 will be described, and in FIGS. 12 to 14, the display forms of the special gauge icon g13 will be described. In the display forms described with reference to FIGS. 8 to 14, it is assumed that the user keeps pressing the R1 key 35.

FIG. 8 is an enlarged view illustrating the display form of the special gauge icon g11 in a state where the player character can activate the skill.

In the display form illustrated in (1) of FIG. 8, the color area all of the special gauge icon g11 emits light in a state of being fully accumulated. The light emission of the color area all of the special gauge icon g11 indicates to the user that the player character is in a state of being capable of activating the skill.

In the display form illustrated in (2) of FIG. 8, a light emission effect e11-1 is displayed around the special gauge icon g11. For example, the light emission effect e11-1 emits light in a color different from the light emission color of the color area all and in a range larger than the special gauge icon g11. In addition, the light emission effect e11-1 is displayed at regular time intervals. The light emission effect e11-1 allows the user to clearly recognize that the player character is in a state of being capable of activating the skill.

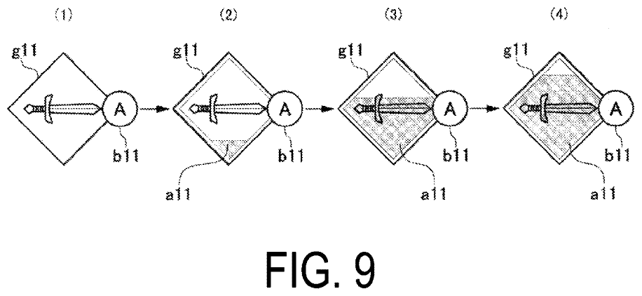

FIG. 9 is an enlarged view illustrating the display form of the special gauge icon g11 during a cooldown period.

When the player character activates the skill, the player character transitions to the cooldown period. The cooldown period is a waiting time required for the player character to enter a state of being capable of activating the skill again.

In the display form illustrated in (1) of FIG. 9, the special gauge icon g11 immediately after the skill activation is illustrated. At this time, the color area all of the special gauge icon g11 disappears, and the special gauge icon g11 is displayed with reduced brightness. The display form illustrated in (1) of FIG. 9 represents a state in which the player character cannot activate the skill.

The display forms illustrated in (2), (3), and (4) of FIG. 9 represent states in which the color area all is gradually accumulated in the special gauge icon g11. By indicating a change in the form in which the color area all is accumulated in the special gauge icon g11, it is possible to raise the expectation of the user until entering a state of being capable of activating the skill.

After activating the skill, the player character transitions to the cooldown period. Although the player character cannot activate the skill during the cooldown period, the user desires to know at which point of time the skill can be activated. Therefore, when the display form of the special gauge icon g11 changes during the cooldown period, the user can know how long it is necessary to wait until the player character enters a state of being capable of activating the skill.

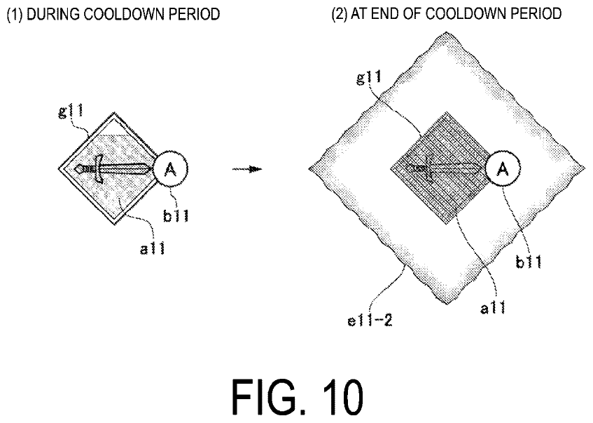

FIG. 10 is an enlarged view illustrating the display form of the special gauge icon g11 at the end of the cooldown period. Here, the display forms of the special gauge icon g11 during and at the end of the cooldown period will be described separately.

The display form during the cooldown period illustrated in (1) of FIG. 10 is the same as the display form illustrated in (4) of FIG. 9.

The display form at the end of the cooldown period illustrated in (2) of FIG. 10 is displayed in a state in which the special gauge icon g11 is filled with the color area all. In addition, at the moment when the special gauge icon g11 is filled with the color area all, a light emission effect e11-2 is displayed around the special gauge icon g11. The light emission effect e11-2 causes the special gauge icon g11 to brightly emit light, thereby making it possible to notify the user that the player character enters a state of being capable of activating the skill.

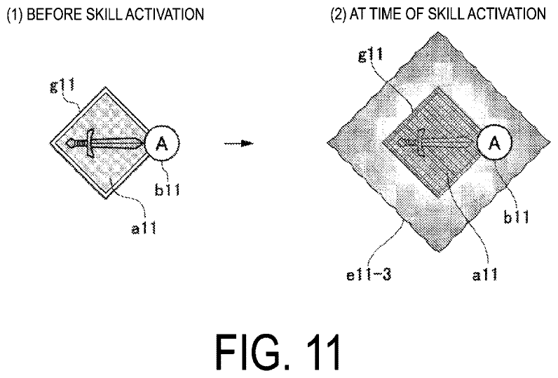

FIG. 11 is an enlarged view illustrating the display form of the special gauge icon g11 at the time of skill activation. Here, the display forms of the special gauge icon g11 before and at the time of the skill activation will be described separately.

In the display form before the skill activation illustrated in (1) of FIG. 11, the special gauge icon g11 is displayed in a state of being filled with the color area all.

In the display form at the time of the skill activation illustrated in (2) of FIG. 11, the special gauge icon g11 is displayed in a state in which a light emission effect e11-3 is displayed around the special gauge icon g11. When the user performs an operation of activating the skill (an operation of pressing the “A” button while pressing the R1 key 35 of the operation controller 3), the light emission effect e11-3 causes the special gauge icon g11 to brightly emit light, and the character activates the skill. The light emission of the light emission effect e11-3 makes it possible to notify the user that the player character has activated the skill.

Display Form of Specific Area for Notifying User of Skill that Player Character can Consecutively Activate

There are various types of skills. Here, with reference to FIGS. 12 to 14, a description will be given of a display form of the specific area 42A for notifying the user of a skill that the player character can consecutively activate in a short period of time (for example, 30 seconds).

### Display Example of Specific Area Including Remaining Number Icon

FIG. 12 is an enlarged view illustrating a display example of the specific area 42A in which a remaining number icon t13 is displayed. In the specific area 42A illustrated in FIG. 12, the special operation areas n11 to n14 and the guide areas n15 and n16 illustrated in FIG. 7 are omitted to avoid complicating the drawing.

The remaining number icon t13 is an example of an area for the number of executable times, which indicates the number of times the special operation can be executed. When the operation mode is the special operation mode, the screen rendering unit 104 renders, at an inner side of the button icons b11 to b14, the remaining number icon t13 indicating the number of times the user can execute the special operation, that is, the remaining number of times the player character can consecutively activate the skill in a short period of time. Then, the screen output part 105 outputs, to the display apparatus 4, the screen 41 on which the specific area 42A including the remaining number icon t13 is rendered.

Here, as the number of times the player character can activate Skill 3, the remaining number icon t13 is displayed at an inner side of the special gauge icon g13 and the button icon b13. Here, “2” is displayed in the remaining number icon t13 to indicate that the remaining number of times the player character can activate Skill 3 is two. Here, the remaining number of times displayed in the remaining number icon t13 changes depending on the size of the color area a13 of the special gauge icon g13. In the example illustrated in FIG. 12, it can be seen that the number of times the player character can activate Skill 3 is two when the special gauge icon g13 is filled with the color area a13.

### Appearance of Decrease in Color Area

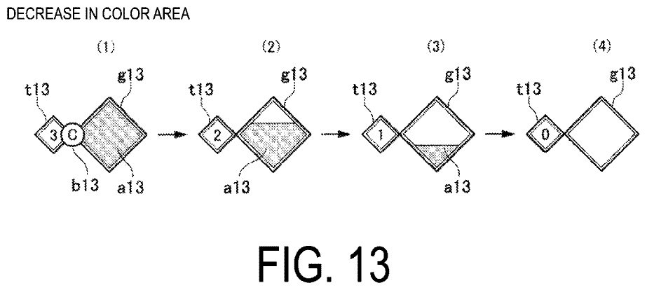

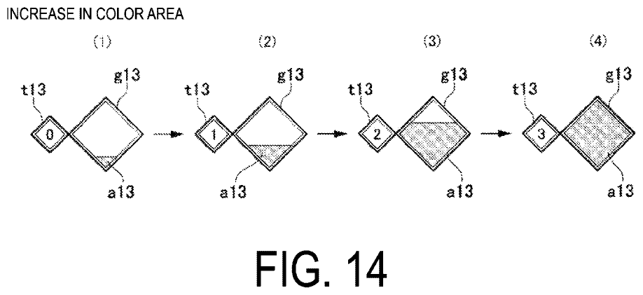

FIG. 13 is an enlarged view illustrating how the special gauge icon g13 changes when the player character consecutively activates the skill. In the examples illustrated in FIGS. 13 and 14, it is assumed that when the special gauge icon g13 is filled with the color area a13, the player character can consecutively activate Skill 3 up to three times.

In the display form illustrated in (1) of FIG. 13, the special gauge icon g13 is fully filled with the color area a13, and “3” is displayed in the remaining number icon t13. This indicates that the remaining number of times of the skill can be activated is three. In the case of the skill that the player character can consecutively activate, for example, a length of the special gauge icon g13 from a lower vertex to an upper vertex is divided by the maximum number of times the skill can be activated, and positions obtained by the division are associated with a height of the color area a13. For example, it is assumed that when the player character can consecutively activate the skill up to three times, the character can activate the skill once when the height of the color area a13 from the lower vertex reaches one third of the length of the special gauge icon g13 from the lower vertex to the upper vertex.

The display form illustrated in (2) of FIG. 13 indicates a state after the player character uses the skill once. At this time, the color area a13 partially decreases in the special gauge icon g13. Then, the height of the color area a13 from the lower vertex becomes two thirds of the length of the special gauge icon g13 from the lower vertex to the upper vertex, and “2” is displayed in the remaining number icon t13.

The display form illustrated in (3) of FIG. 13 indicates a state after the player character uses the skill one more time. At this time, the color area a13 further decreases in the special gauge icon g13. At this time, the height of the color area a13 from the lower vertex becomes one third of the length of the special gauge icon g13 from the lower vertex to the upper vertex, and “1” is displayed in the remaining number icon t13.

The display form illustrated in (4) of FIG. 13 indicates a state after the player character uses the skill one more time. At this time, the color area a13 disappears from the special gauge icon g13, and “0” is displayed in the remaining number icon t13. Therefore, in the display form illustrated in (4) of FIG. 13, the player character cannot activate the skill.

### Appearance of Increase in Color Area

FIG. 14 is an enlarged view illustrating how the special gauge icon g13 changes until the player character becomes capable of activating the skill. The color area a13 of the special gauge icon g13 increases with time.

In the display form illustrated in (1) of FIG. 14, only a small amount of the color area a13 is accumulated in the special gauge icon g13, and “0” is displayed in the remaining number icon t13. Therefore, the player character cannot activate the skill.

In the display form illustrated in (2) of FIG. 14, the color area a13 is accumulated in the special gauge icon g13. At this time, the height of the color area a13 from the lower vertex becomes one third of the length of the special gauge icon g13 from the lower vertex to the upper vertex, and “1” is displayed in the remaining number icon t13. Therefore, in the display form illustrated in (2) of FIG. 14, the player character can activate the skill once.

In the display form illustrated in (3) of FIG. 14, the color area a13 is accumulated to more than half of the special gauge icon g13. At this time, the height of the color area a13 from the lower vertex becomes two thirds of the length of the special gauge icon g13 from the lower vertex to the upper vertex, and “2” is displayed in the remaining number icon t13. Therefore, in the display form illustrated in (3) of FIG. 14, the player character can activate the skill twice.

In the display form illustrated in (4) of FIG. 14, the special gauge icon g13 is fully filled with the color area a13, and “3” is displayed in the remaining number icon t13. Therefore, in the display form illustrated in (4) of FIG. 14, the player character can activate the skill three times.

As illustrated in FIGS. 13 and 14, the color area a13 is accumulated in the special gauge icon g13 according to the remaining number of times the player character can activate the skill, and the remaining number of times is displayed in the remaining number icon t13. Here, it is assumed that when the color area a13 is accumulated, the height of the color area a13 changes at a constant speed from the lower vertex to the upper vertex of the special gauge icon g13. However, the height of the color area a13 does not necessarily need to change at a constant speed.

In addition, it is possible to change the height of the color area a13 from the lower vertex with respect to the length of the special gauge icon g13 from the lower vertex to the upper vertex in accordance with the maximum number of times the player character can consecutively activate the skill. For example, when the player character can consecutively activate the skill up to n times, and the height of the color area a13 from the lower vertex reaches 1/n of the length of the special gauge icon g13 from the lower vertex to the upper vertex, the character may be capable of activating the skill once.

### Example of Processing of Information Processing Apparatus

Next, an example of processing of the information processing apparatus 2 (see FIG. 4) will be described.

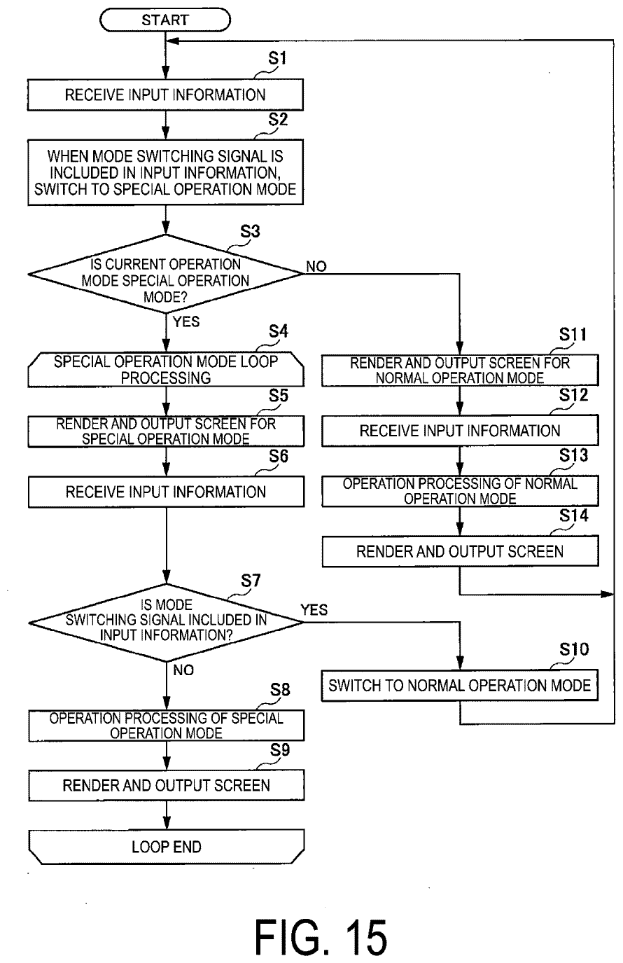

FIG. 15 is a flowchart illustrating the example of the processing of the information processing apparatus 2. It is assumed that the operation mode at the time of starting this processing is set to the normal operation mode.

First, the input reception unit 101 receives input information from the operation controller 3 (S1). This input information includes, for example, any of an operation signal from the right stick key 31, an operation signal from the left stick key 32, operation signals from the operation buttons 33, an operation signal from the directional pad 34, and an operation signal from the R1 key 35, the R2 key 36, the L1 key 37, or the L2 key 38. Note that a mode switching signal of the R1 key 35 is included in the operation signal described above.

Next, when a mode switching signal serving as an instruction to switch the operation mode is included in the input information received by the input reception unit 101, the mode switching unit 102 switches the operation mode to the special operation mode (S2). For example, when the operation signal from the R1 key 35 is included in the input information, the mode switching unit 102 switches the operation mode from the normal operation mode to the special operation mode.

The object action unit 103 determines whether the current operation mode is the special operation mode (S3). When it is determined that the current operation mode is the special operation mode (YES in S3), loop processing of the special operation mode starts (S4).

In this loop processing, the screen rendering unit 104 renders a screen for the special operation mode, and the screen output part 105 outputs the rendered screen to the display apparatus 4 (S5). At this time, the specific area 42A when the operation mode is the special operation mode, which is illustrated in FIG. 7, is displayed on the screen 41 of the display apparatus 4.

Next, the input reception unit 101 receives input information from the operation controller 3 (S6). Next, the mode switching unit 102 determines whether a mode switching signal serving as an instruction to switch the operation mode is included in the input information received by the input reception unit 101 (S7). For example, when the user keeps pressing the R1 key 35, the mode switching signal is not included in the input information.

Therefore, when it is determined that the mode switching signal is not included in the input information (NO in S7), the user operates the player character using another operation button or the like while pressing the R1 key 35.

In this way, when the user keeps pressing the R1 key 35, the mode switching signal is in the ON state. Thus, the switching instruction can be considered to be continuously input. While the switching instruction is continuously input, that is, while the user presses the R1 key 35, the mode switching unit 102 maintains the operation mode in the special operation mode. Therefore, the object action unit 103 performs operation processing in the special operation mode (S8). For this reason, the player character can perform an action of activating a skill, or the like.

Next, the screen rendering unit 104 renders a screen including the player character operated in the special operation mode, and the screen output part 105 outputs the rendered screen to the display apparatus 4 (S9). Subsequently, the processing returns to step S5 again, and the loop processing of the special operation mode is repeated.

On the other hand, when the user removes their finger from the pressed R1 key 35, a mode switching signal is included in the input information. Therefore, when it is determined in step S7 that the mode switching signal is included in the input information (YES in S7), the user is in a state in which their finger is removed from the R1 key 35. In this way, when the user stops pressing the R1 key 35, the mode switching signal enters the OFF state. Thus, the input of the switching instruction can be considered to have been stopped. When the input of the switching instruction by the user is stopped, that is, when the user stops pressing the R1 key 35, the mode switching unit 102 switches the operation mode from the special operation mode to the normal operation mode (S10), and exits from the loop processing of the special operation mode. Then, the processing returns to step S1 again.

In step S3, when the object action unit 103 determines that the current operation mode is not the special operation mode (NO in S3), that is, the normal operation mode, the screen rendering unit 104 renders a screen for the normal operation mode, and the screen output part 105 outputs the rendered screen to the display apparatus 4 (S11). At this time, the specific area 42 when the operation mode is the normal operation mode, which is illustrated in FIG. 5, is displayed on the screen 41 of the display apparatus 4.

Next, the input reception unit 101 receives input information from the operation controller 3 (S12). Then, the object action unit 103 performs operation processing in the normal operation mode (S13). Therefore, the player character can perform a normal action or the like without activating a skill.

Next, the screen rendering unit 104 renders a screen including the player character operated in the normal operation mode, and the screen output part 105 outputs the rendered screen to the display apparatus 4 (S14). Subsequently, the processing returns to step S1 again and is repeated.

In the information processing apparatus 2 according to the embodiment described above, the normal gauge icons g1 to g4 are displayed at the inner side of the button icons b1 to b4 provided in the specific area 42 in the normal operation mode. Even in the normal operation mode, the user can easily recognize whether the character has entered a state of being capable of activating the skill from a situation in which the color area is being accumulated in each of the normal gauge icons g1 to g4. In the special operation mode, the special gauge icons g11 to g14 are displayed at the outer side of the button icons b11 to b14 provided in the specific area 42A. Here, when the operation mode is switched from the normal operation mode to the special operation mode, the normal gauge icons g1 to g4 (see FIG. 5) displayed at the inner side of the button icons b1 to b4 are displayed as the special gauge icons g11 to g14 (see FIG. 7) moved to the at the outer side of the button icons b11 to b14. Therefore, it is possible to give the user a clear indication that the operation mode has been switched to the special operation mode.

The special operation areas n11 to n14 are also displayed for the special gauge icons g11 to g14. In the special operation areas n11 to n14, the contents of the skills associated with the button icons b11 to b14 are displayed. Thus, while checking the contents of the skills displayed in the special operation areas g11 to g14, the user can perform a special operation of causing the character to activate an activatable skill indicated by each of the special gauge icons n11 to n14. In this way, since the specific areas 42 and 42A are displayed in a switched manner according to the operation mode, only information necessary and sufficient for the user's operation is displayed. Since the operation contents of the operations executable by the user are shown in the specific area 42 or 42A, the user can easily recognize the operation contents to be executed.

The button icons b1 to b4 and b11 to b14 are arranged at the positions corresponding to each of the operation buttons 33 of the operation controller 3. Therefore, the user can execute the normal operation or the special operation without checking the operation controller 3 at hand, which improves convenience in the operation.

The light emission effect e11-1 illustrated in FIG. 8 and the light emission effect e11-2 illustrated in FIG. 10 indicate that the color area is accumulated in each of the special gauge icons g11 to g14 and the character can activate the skill. Therefore, even in a situation in which there are a large number of enemies or the screen rapidly changes, the user can easily recognize that the player character is in a state of being capable of activating the skill. Moreover, the light emission effect e11-3 illustrated in FIG. 11 notifies the user that the character has activated the skill. Therefore, the user can easily recognize that the user has intentionally performed the special operation to cause the character to activate the skill.

In addition, when there is a skill that can be consecutively activated, the number of times the player character can consecutively activate the skill in a short period of time is displayed in the display forms illustrated in FIGS. 12 to 14. For this reason, the user recognizes the number of times the skill can be activated while checking the remaining number icon t13, which makes it easy for the user to consider a strategy (at which timing the skill is to be activated, or the like) at the time of a battle or the like.

### MODIFIED EXAMPLE

The operation controller 3 according to the above-described embodiment outputs a mode switching signal to the information processing apparatus 2 both when the user presses the R1 key 35 with their finger and when the user removes their finger from the R1 key 35. However, when the player character or an enemy character displayed on the screen 41 moves violently, some users have difficulty in pressing or releasing the R1 key 35.

Therefore, when the user selects “easy” as the difficulty level of the game, the setting may be changed so that a mode switching signal is output from the operation controller 3 to the information processing apparatus 2 only when the R1 key 35 is pressed.

In this case, when the user presses the R1 key 35, a mode switching signal serving as an instruction to switch the operation mode is output from the operation controller 3 to the information processing apparatus 2. When the mode switching signal is input from the operation controller 3, the mode switching unit 102 switches the operation mode to the special operation mode in the processing in step S2 of FIG. 15. At this time, the mode switching signal enters the ON state. After the user presses the R1 key 35, a mode switching signal is not output from the operation controller 3 to the information processing apparatus 2 even when the user removes their finger from the R1 key 35, and the mode switching unit 102 maintains the operation mode in the special operation mode. Therefore, in the processing in step S7 of FIG. 15, it is determined that the mode switching signal is not included in the input information (NO in S7). At this time, although the mode switching signal is in the ON state, the input of the switching instruction can be considered to have been stopped. Subsequently, when the R1 key 35 is pressed again, a mode switching signal is input again from the operation controller 3 to the information processing apparatus 2. Therefore, in the processing in step S7 of FIG. 15, it is determined that the mode switching signal is included in the input information (YES in S7). Then, the mode switching unit 102 switches the operation mode from the special operation mode to the normal operation mode (S10). In this way, the user can perform a special operation even in a state in which the R1 key 35 is pressed once and then their finger is removed from the R1 key 35. Further, only the R1 key 35 needs to be pressed again to return the special operation mode to the normal operation mode, thus even a user who is not familiar with action games can enjoy the game.

When the mode switching signal is input as the switching instruction from the operation controller 3, the screen rendering unit 104 may render text or an image different for each character in an area at the inner side of the button icons b11 to b14. For example, the screen rendering unit 104 may render stats such as the current class and level depending on the character. By rendering and displaying the stats unique to the character in this way, the user can easily check the stats of the character currently being operated without switching the screen display.

The rendering processing of the specific areas 42 and 42A according to the above-described embodiment can be applied to multiplayer in which a plurality of users simultaneously participate in one scene and a plurality of characters are operated. In the multiplayer, in addition to the specific area 42 or 42A of the character operated by the user being displayed on the display apparatus 4, the specific area 42 or 42A of a character operated by another user may be displayed on the display apparatus 4. In this case, the user can know whether the character operated by the other user is in a state of being capable of activating a skill. Therefore, the user can perform an operation of combining the skill activated by their own character with the skill activated by the other character during an operation using a group including a plurality of characters as members.

Note that the present invention is not limited to the above-described embodiment, and various other applications and modified examples can be naturally made without departing from the gist of the present invention described in the claims.

For example, the above-described embodiment is intended to describe the configuration of the information processing apparatus 2 in detail and specifically in order to describe the present invention in an easy-to-understand manner, but the present invention is not necessarily limited to the embodiment including all the described configurations. In addition, another configuration can be added to a part of the configuration of the present embodiment, or such a part can be deleted or replaced.

In addition, control lines and information lines that are considered to be necessary for description are illustrated, and all control lines and information lines in a product are not necessarily illustrated. It may be conceivable that almost all the components are actually connected to each other.

### REFERENCE SIGNS LIST

1 Image rendering system, 2 Information processing apparatus, 3 Operation controller, 4 Display apparatus, 5 Content distribution server, 35 R1 key, 41 Screen, 42, 42A Specific area, 101 Input reception unit, 102 Mode switching unit, 103 Object action unit, 104 Screen rendering unit, 105 Screen output part, b1 to b4, b11 to b14 Button icon, c1, c11 Specific position, g1 to g4 Normal gauge icon, g11 to g14 Special gauge icon, n1 to n4 Normal operation area, n11 to n14 Special operation area

What is claimed is:

1. A program for rendering a screen including, as a part of the screen, a specific area for showing how to perform an operation of a game to be performed via an input part, the program causing a computer to execute:
rendering, when an operation mode of the game is a normal operation mode, the specific area including
at least three selection operation areas provided in a manner corresponding to selection operation portions provided at the input part, the at least three selection operation areas being arranged to surround a specific position in the specific area,
normal operation areas provided at an outer side of the at least three selection operation areas in a manner corresponding to the at least three selection operation areas, the normal operation areas indicating contents of normal operations in the normal operation mode, and
first special operation areas provided at an inner side of the at least three selection operation areas in a manner corresponding to the at least three selection operation areas, the first special operation areas indicating contents of special operations in a special operation mode different from the normal operation mode;
switching the operation mode from the normal operation mode to the special operation mode through a switching instruction of the operation mode being input from the input part; and
rendering, when the operation mode is the special operation mode, the specific area in which second special operation areas corresponding to the first special operation areas are arranged at an outer side of the first special operation areas.

2. The program according to claim 1, the program causing the computer to execute:
rendering at least one set of the first special operation areas or the second special operation areas while continuously moving the at least one set of the first special operation areas or the second special operation areas from an inner side to an outer side of the at least three selection operation areas by inputting the switching instruction from the input part.

3. The program according to claim 2, the program causing the computer to execute:
rendering, when the operation mode is the special operation mode, text or images representing the contents of the special operations at positions corresponding to positions of the second special operation areas.

4. The program according to claim 3, the program causing the computer to execute:
rendering a parameter indicating whether the special operation is executable in the first special operation areas and the second special operation areas.

5. The program according to claim 4, wherein
the parameter increases under a predetermined condition, the special operation becomes executable when the parameter exceeds a predetermined value, and the parameter decreases when the special operation is executed.

6. The program according to claim 5, the program causing the computer to execute:
rendering the parameter in a different color depending on the special operation.

7. The program according to claim 4, the program causing the computer to execute:
rendering the second special operation area when the operation mode is the special operation mode in a larger area than the first special operation area when the operation mode is the normal operation mode.

8. The program according to claim 4, the program causing the computer to execute:
maintaining the operation mode in the special operation mode while the switching instruction is continuously input, and switching the operation mode to the normal operation mode when input of the switching instruction is stopped.

9. The program according to claim 4, the program causing the computer to execute:
maintaining the operation mode in the special operation mode when the switching instruction is input, and switching the operation mode to the normal operation mode when input of the switching instruction is stopped and then the switching instruction is input again.

10. An image rendering method for rendering a screen including, as a part of the screen, a specific area for showing how to perform an operation of a game to be performed via an input part, the image rendering method comprising:
a step of rendering, when an operation mode of the game is a normal operation mode, the specific area including
at least three selection operation areas provided in a manner corresponding to selection operation portions provided at the input part, the at least three selection operation areas being arranged to surround a specific position in the specific area,
normal operation areas provided at an outer side of the at least three selection operation areas in a manner corresponding to the at least three selection operation areas, the normal operation areas indicating contents of normal operations in the normal operation mode, and
first special operation areas provided at an inner side of the at least three selection operation areas in a manner corresponding to the at least three selection operation areas, the first special operation areas indicating contents of special operations in a special operation mode different from the normal operation mode;
a step of switching the operation mode from the normal operation mode to the special operation mode through a switching instruction of the operation mode being input from the input part; and
a step of rendering, when the operation mode is the special operation mode, the specific area in which second special operation areas corresponding to the first special operation areas are arranged at an outer side of the first special operation areas.

11. A game apparatus for rendering a screen including, as a part of the screen, a specific area for showing how to perform an operation of a game to be performed via an input part, the game apparatus comprising:
a rendering unit configured to render, when an operation mode of the game is a normal operation mode, the specific area including
at least three selection operation areas provided in a manner corresponding to selection operation portions provided at the input part, the at least three selection operation areas being arranged to surround a specific position in the specific area,
normal operation areas provided at an outer side of the at least three selection operation areas in a manner corresponding to the at least three selection operation areas, the normal operation areas indicating contents of normal operations in the normal operation mode, and
first special operation areas provided at an inner side of the at least three selection operation areas in a manner corresponding to the at least three selection operation areas, the first special operation areas indicating contents of special operations in a special operation mode different from the normal operation mode; and
an operation mode switching unit configured to switch the operation mode from the normal operation mode to the special operation mode through a switching instruction of the operation mode being input from the input part, wherein
the rendering unit renders, when the operation mode is the special operation mode, the specific area in which second special operation areas corresponding to the first special operation areas are arranged at an outer side of the first special operation areas.
